(19) United States
(12) Patent Application Publication
(10) Pub. No.: US 2007/0201132 A1
(43) Pub. Date: Aug. 30, 2007

(54) Rear projection television optics

(76) Inventors: Bruce L. Cannon, Portland, OR (US); R. Edward English JR., Cincinnati, OH (US)

Correspondence Address: 3M INNOVATIVE PROPERTIES COMPANY, PO BOX 33427, ST. PAUL, MN, 55133-3427, US

(21) Appl. No.: 11/364,487

(22) Filed: Feb. 27, 2006

(51) Int. Cl. G03B 21/56

(52) U.S. Cl. 359/460

(57) ABSTRACT

The optical path for a rear projection television is disclosed, having emission from a projection lens, an optional reflection from a turning mirror, reflection from a curved mirror, reflection from one or two flat mirrors, and projection onto the rear surface of a viewing screen. When two flat mirrors are present, there is one flat mirror parallel to the screen near the rear of the television cabinet, and the other flat mirror perpendicular to the screen near the top or the bottom of the cabinet. When only one flat mirror is present, it is located near the top or bottom of the cabinet, and is inclined with a small but finite angle toward the screen. The optional turning mirror can allow the lens barrel to be located in an otherwise unused part of the cabinet, and can further reduce the size of the cabinet. The pedestal height divided by the screen height may be less than roughly 1/10, and the casing depth divided by the screen height may be less than roughly ⅓.

### FIELD OF THE INVENTION

The present invention is directed to optical systems for rear projection televisions.

### BACKGROUND

Developments in rear projection televisions are allowing the dimensions of the cabinet to shrink, by arranging the optical system inside the cabinet with a particular geometry. In many of these geometries, there is a prominent cabinet space between the edge of the screen and the edge of the cabinet. The space above the screen may be known as “brow” or “forehead”, while the space below the screen may be known as “chin” or “pedestal”. Both “brow” and “chin” dimensions may be substantial, compared with other classes of televisions that do not use rear projections. Furthermore, some of these geometries may use multiple mirror reflections.

### BRIEF SUMMARY

The present application discloses, inter alia, a rear projection optical system for forming an image at an at least partially transmissive viewing panel from a first beam emitted from a projection lens, comprising a curved mirror for receiving the first beam and reflecting a second beam; a first substantially planar mirror for receiving the second beam and reflecting a third beam; and a second substantially planar mirror for receiving the third beam and reflecting a fourth beam. The at least partially transmissive viewing panel receives the fourth beam.

Also disclosed is a rear projection optical system for forming an image at an at least partially transmissive viewing panel from a first beam emitted from a projection lens, comprising a curved mirror for receiving the first beam and reflecting a second beam; and a substantially planar mirror for receiving the second beam and reflecting a third beam, the substantially planar mirror being non-parallel to the at least partially transmissive viewing panel. The at least partially transmissive viewing panel receives the third beam.

Also disclosed is a rear projection television, comprising a casing having a projection screen; a projection lens that does not include any curved mirrors; and an optical path from the projection lens to the projection screen, the optical path including exactly one curved mirror and at least one substantially planar mirror that is non-parallel to the at least partially transmissive viewing panel.

Also disclosed is a rear projection television, comprising a casing having a casing depth and a casing front surface, the casing front surface having a bottom edge; a projection screen embedded in and surrounded by the casing front surface, the projection screen having a screen height; a projection lens; and an optical path extending between the projection lens and the projection screen. The optical path is entirely inside the casing. A pedestal height is formed between the bottom of the projection screen and the bottom edge of the casing front surface. The pedestal height divided by the screen height is less than roughly 1/10. The casing depth divided by the screen height is less than roughly ⅓. The optical path includes at most three reflections.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1(a) is a plan view of a first embodiment of an optical system for a rear projection television.

FIGS. 1(b), 1(c) and 1(d) are perspective views of the optical system of FIG. I (a).

FIG. 2 is a plan view of a second embodiment of an optical system for a rear projection television.

FIG. 3(a) is a plan view of a third embodiment of an optical system for a rear projection television.

FIGS. 3(b), 3(c) and 3(d) are perspective views of the optical system of FIG. 3(a).

FIG. 4 is a plan view of a fourth embodiment of an optical system for a rear projection television.

FIG. 5 is a perspective view of a rear projection television.

FIG. 6 is a plan view of a portion of a Fresnel lens.

### DETAILED DESCRIPTION OF ILLUSTRATIVE EMBODIMENTS

There are ongoing improvements to large-screen, rear projection televisions. For a particular screen size, there are continuing efforts to make the television cabinet smaller and the television set less expensive. Many of these improvements are driven by the choice of optical components and the geometry of how they are arranged inside the television.

One factor that drives an optical layout inside the cabinet is a size target. For instance, a particular set of dimensions may be deemed desirable, and the optics and layout inside the cabinet may be chosen to achieve the desired dimensions. Using known optical components and/or known layouts, these target dimensions may prove prohibitively expensive, or may be difficult to achieve based on technical requirements. An exemplary set of target dimensions is described below, following a brief description of several of the cabinet dimensions themselves.

The reader is referred to FIG. 5, which shows a rear projection television 50, with a viewing panel 11 embedded in and surrounded by its front face. It is instructive to define various dimensions of the television. The viewing panel 11 is generally rectangular, with an aspect ratio of 4:3 or 16:9, although other aspect ratios may be used. For most large rear-projection televisions currently in the marketplace, the most common aspect ratio is 16:9, especially for televisions with large diagonal dimensions, such as 60 inches (152 cm). The screen height 51 is the distance between the top and bottom of the viewing panel 11. The casing depth 53 is the distance between the front and rear sides of the casing. The pedestal height 52 is the distance between the bottom of the viewing panel 11 and the bottom of the television casing. The pedestal height may also be known as a “chin” height or a chin size; an analogous dimension at the top of the viewing panel 11 may be known as a “brow” height or brow size, or, similarly, a forehead height or size. In general, it is considered desirable to reduce both the pedestal (or chin) height and the brow height, so that the rear projection television may more closely resemble more expensive televisions, such as those using plasma or LCD screens.

It is instructive to describe a target set of design requirements that would be highly desirable in the marketplace, but has proven difficult to achieve using known optics and/or a known folding geometry. This target may be summarized by the following two simultaneous requirements:

(1) The pedestal height 52 divided by the screen height 51 should be less than roughly 1/10, and

(2) The casing depth 53 divided by the screen height 51 should be less than roughly ⅓.

The geometrical layouts described herein and shown in the figures are motivated in part by these two design requirements. A detailed numerical analysis of several of these specific layouts is provided below, following a more general description of the optics and the layouts themselves.

The optics used inside a rear projection television typically includes a wide-angle projection lens. These wide-angle lenses typically have multiple refractive elements, which may be mounted in a lens barrel that keeps the elements aligned and spaced properly with respect to each other. During the design and layout stage, during which the lenses and layouts may be simulated, it is found that as the required half field of view of the lens increases, the lens requires more and more elements for adequate correction, which can increase the size of the lens. At some point in the design stage, it becomes impractical to increase the half field of view any further, because the resulting lens becomes too large to fit in the allocated volume envelope inside the cabinet.

One option for reducing the size of the wide-angle lens while maintaining a large half field of view is to use a curved mirror that lies external to the lens barrel. During the design stage, the mirror surface may be used in combination with the refractive elements to optimize performance. For instance, the curvature and optional conic and/or aspheric coefficients of the mirror may be varied along with similar parameters for each of the refractive surfaces, during typical optimization steps for the optical system. In this manner, some correction in the optical system may be provided by the curved mirror, which can potentially reduce the number of refractive elements required, and may even reduce the size of the lens barrel itself.

Use of curved mirrors in addition to the refractive lens elements also has a point of diminishing returns. Although using a curved mirror can potentially reduce the size and/or number of required refractive elements, a curved mirror has manufacturing and alignment costs associated with it. For that reason, curved mirrors are typically used sparingly in rear projection television layouts. It is found that a single curved mirror, placed after the refractive elements, can provide a cost-effective way to reduce the size and/or number of the required refractive elements while maintaining a large half field of view. But in general, use of two or more curved mirrors in the optical system can drive up the cost of production, alignment and assembly beyond that which may be acceptable in the marketplace.

It is found that a rear projection television cabinet that uses an optical system with a single, curved mirror, located after the projection lens, can simultaneously satisfy requirements (1) and (2) above. Furthermore, because only one curved mirror is used, the production, alignment and assembly costs of such an optical system may be low enough to be acceptable in the marketplace.

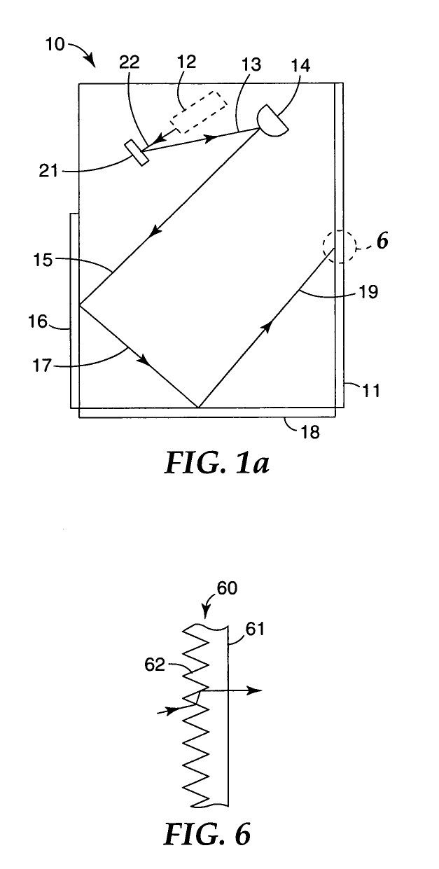

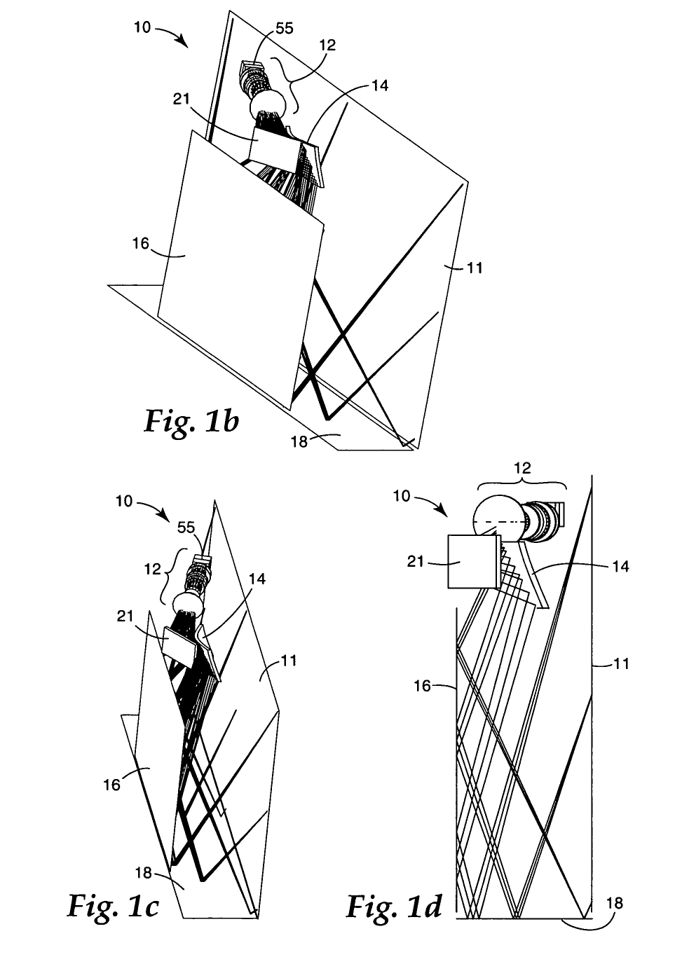

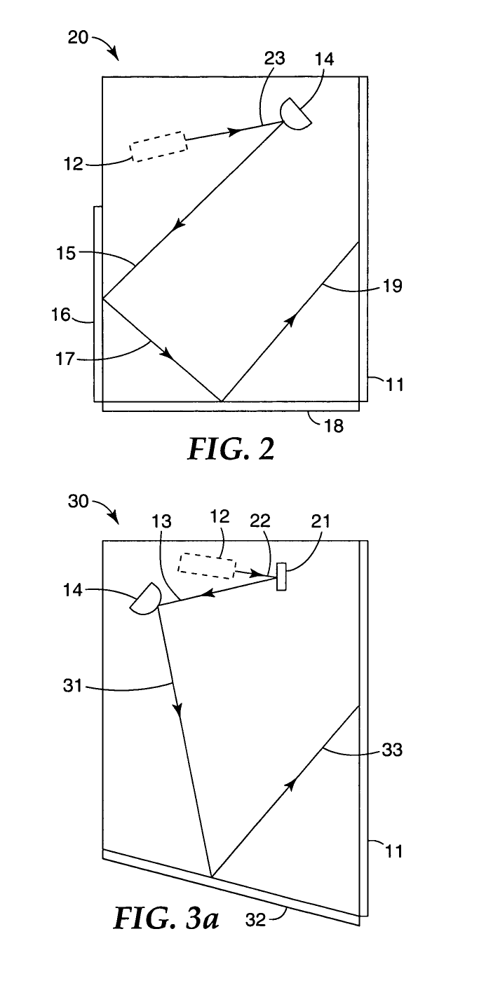

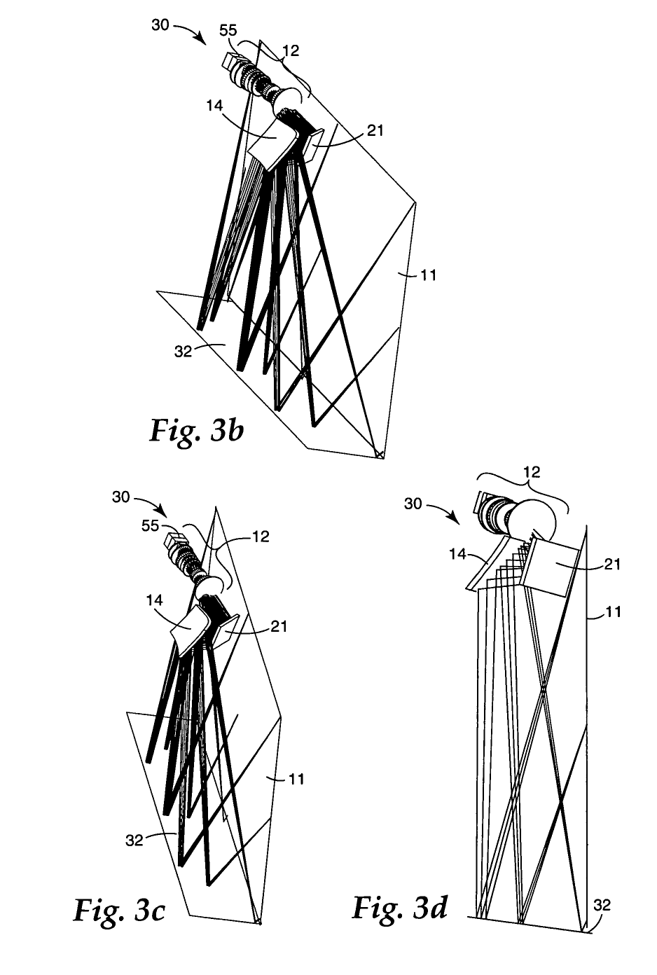

FIGS. 1 through 4 show four embodiments of an optical system that uses a single, curved mirror. Each of these four embodiments can satisfy the size target requirements (1) and (2) simultaneously. The following paragraphs provide a general description of the cabinet geometry for these embodiments, after which detailed numerical analysis is provided for the geometries shown in FIGS. 1(a)-1(d) and FIGS. 3(a)-3(d).

FIGS. 1(a)-1(d) show embodiments of an optical system 10 for a rear projection television set. FIG. 1(a) shows a single ray in the center of the field of view, while FIGS. 1(b), 1(c) and 1(d) show multiple rays at the top, center and bottom of the field of view.

The image that is to be projected on the viewing panel of the television is typically generated on a relatively small, pixelated panel, which may be referred to as the “object” of the optical system. The object may generate its own light, or it may be illuminated by an external source. For instance, a liquid crystal on silicon (LCOS) panel may be used as an object along with one or more polarizers, where a beam reflected off the LCOS panel may be attenuated on a pixel-by-pixel basis. Alternatively, the pixelated panel may be a high temperature polysilicon device, such as a Liquid Crystal Display (LCD), which may attenuate a transmitted beam on a pixel-by-pixel basis. As a further alternative, the pixelated panel may be a Digital Micromirror Device, formed as an array of tiny, controllable mirrors that can modulate a reflected beam on a pixel-by-pixel basis. As yet another alternative, the pixilated panel may generate its own light, such as an array of light emitting diodes. It should be noted that while a pixelated panel is described as one typical object, any suitable object may be used.

The pixelated panel is located at the object plane of the projection lens, and the viewing panel or screen of the television is located at the image plane of the projection lens. The projection lens may optionally have a magnification chosen to match the size of the image with the size of the viewing panel; both may be generally rectangular in shape, typically with a 4:3 or a 16:9 aspect ratio, although other shapes and sizes may be used.

The object, or pixelated panel, may be placed off-center with respect to the optical axis of the projection lens, which may loosen some of the field-of-view requirements of the lens. In some cases, the object may be located entirely on one side of the optical axis, so that light leaving the object arrives at the viewing panel in the outermost edge of the field of view. Consider the following numerical example, which is merely illustrative and is not intended to be limiting in any way. For a lens having, a 75 degree half field of view, the object may be situated far enough off-axis so that the roughly rectangular image at the viewing panel uses only half field of view angles between 55 degrees and 75 degrees. In this manner, the projection lens need only be well-corrected for half field of view angles between 55 degrees and 75 degrees, with half field of view angles between 0 degrees and 55 degrees effectively being unused by the television. As such, the design requirements of the projection lens, such as a flat field, reduced chromatic aberration and reduced distortion, need only apply at half field of view angles between 55 degrees and 75 degrees. Satisfying the design requirements only for half field of view angles between 55 degrees and 75 degrees is generally much easier than satisfying them for all angles between 0 degrees and 75 degrees. The numerical values provided in this paragraph are intended only as examples, and are not limiting in any way.

The projection lens typically has multiple refractive elements, usually with each element having a rotational symmetry about the optical axis. Each element is typically made of only one material, and it is common for a projection lens to use two or more different materials among its elements so that chromatic aberration may be corrected. Optionally, one or more of the elements may have a diffractive component. Additionally, one or more elements may be attached or bonded to each other, as well as spaced apart from each other. Furthermore, one or more of the elements may be reflective in nature, which leads to a catadioptric projection lens (i.e., having both refractive and reflective components).

The projection lens is represented by element 12 in FIG. 1, and the object (or pixelated panel) is denoted by element 55 in FIG. 1(b). The object 55 is located at the object plane of the projection lens 12.

Light emerges from the projection lens 12 in the form of a beam 22. For the purposes of this document, a beam is said to begin at a component and terminate at the next sequential component. For instance, beam 22 begins at the projection lens 12 and terminates at the next sequential component, in this case a turning mirror 21. Light that reflects off the turning mirror 21 forms a new beam 13, which propagates until it strikes the next sequential component, and so forth. For instance, in FIG. 1(a), there are five beams between the projection lens 12 and the viewing panel 11, denoted by elements 22, 13, 15, 17 and 19. Also for the purposes of this document, the optical path is said to be the concatenation of the beams between the projection lens 12 and the viewing panel 11. For instance, in FIG. 1(a), the optical path is denoted by the concatenation of the beams, in order, denoted by elements 22, 13, 15, 17 and 19.

Because the projection lens may have a relatively long chain of optical elements, it may optionally have one or more turning mirrors, which are generally flat mirrors that bend the beam by a particular angle, such as 90 degrees or any other suitable angle, but do not add any additional optical power (or curvature) to the beam. Such a turning mirror may be located anywhere that space allows inside or outside the projection lens, and may help reduce the overall cabinet volume required by the projection lens. In FIGS. 1(a)-1(d), a turning mirror 21 is located external to and adjacent to the projection lens 12. The incident light and reflected light are denoted by beams 22 and 13, respectively.

The projection lens 12 may be designed to work with a curved mirror 14 after its last element. In such a case, the refractive elements of the lens may be packaged together in a lens barrel or other suitable mount, and the curved mirror may be external to the lens barrel. The curved mirror may be a particular off-axis portion of a spherical, aspherical and/or conical surface, corresponding to the particular field of view range in which the projection lens 12 is used. For the purposes of this document, such a curved mirror 14 is said to not be a part of the projection lens 12, and is considered external to the projection lens 12 as described herein. Note that the incident beam 13 and reflected beam 15 have different degrees of collimation; the curved mirror 14 adds a particular non-zero amount of optical power into the optical path, and necessarily changes the degrees of collimation upon reflection.

In the embodiment shown in FIGS. 1(a)-1(d), light reflecting from the curved mirror 14 strikes a flat mirror 16 on the rear face of the television cabinet or casing, then strikes a flat mirror 18 on the bottom face of the casing, and then strikes the viewing panel 11 on the front face of the casing. The flat mirror 16 may be roughly parallel to the viewing panel 11, but may deviate from parallel by a few degrees or more. Likewise, the flat mirror 18 may be roughly perpendicular to both the flat mirror 16 and the viewing panel 11, and may be roughly parallel to the base of the television, but also may deviate from these conditions by a few degrees or more.

Both flat mirrors 16 and 18 are typically manufactured as flat as possible, but there still may be some residual curvatures due to manufacturing errors or deformations during assembly or alignment. In general, the mirrors are considered to be flat or planar if they do not appreciably change the optical power (or curvature) of the reflected light.

Note that in general, the geometry of the optical components may be inverted top-to-bottom, so that the projection lens 12 may reside near the bottom of the cabinet, rather than near the top, as drawn in FIGS. 1(a)-1(d). There may be mechanical reasons for placing the projection lens at the bottom, such as considerations of stability; for instance, it may be preferable to situate the heavy components near the bottom of the television. The geometry may also be inverted left-to-right from that shown in FIGS. 1(a)-1(d).

Light reflected from the two flat mirrors 16 and 18 strikes the viewing panel 11. The conjugate distances are preferably set or adjusted during assembly so that an image of the pixelated panel is formed in the plane of the viewing panel 11, and is preferably free from wavefront aberrations and chromatic aberration. The viewing panel 11 may be a simple pane of glass or other transparent or translucent material, or may have additional structures and/or films to enhance the contrast or the perceived brightness of the image at particular angles. For the purposes of this document, the viewing panel includes any or all of these additional structures, including an optional viewing screen.

One such additional structure is a Fresnel lens 60, which is preferably located at the viewing panel 11, with a faceted side 62 facing the interior of the casing and a flat side 61 facing the viewer. Such an exemplary Fresnel lens 60 is shown in FIG. 6. Since all the light striking the viewing panel has a relatively high angle of incidence, such as between 60 degrees and 75 degrees as used in our earlier example, the facets of the Fresnel lens 60 may employ total internal reflection to bend the light so that it exits at angles near normal exitance. This may help increase the perceived brightness of the image for viewers looking at the viewing panel head-on.

Another optical additional structure is a diffuser, which may scramble the exiting directions of the light in an essentially random manner, so that the perceived brightness of the image may appear more uniform over a variety of viewing angles. It will be appreciated that other brightness enhancing or adjusting films or structures may be used as well.

Although television sets are most commonly used so that their viewing panels are essentially vertical, there may be other possible orientations. For instance, the television may be mounted on the ceiling of a dentist's office, so that a patient may watch while reclined in the dentist's chair. When used in this manner, the viewing panel may actually be horizontal during use. Similarly, in a bar setting, a television may be mounted near the ceiling, with an incline pointing downward, so that during use, the viewing panel may actually have one or more compound angles with respect to a vertical orientation. For the purposes of this document, the viewing panel is assumed to be vertical, and the top edge of the television is assumed to be horizontal. One of ordinary skill in the art may readily tilt the television to have any desired orientation; the terms “vertical” and “horizontal” as used in this document are intended to coincide with the nominal planes of the viewing panel and the topmost edge of the television, respectively.

Returning to the discussion of the embodiments of FIGS. 1 through 4, FIG. 2 shows an optical system 20 similar to that of FIG. 1, but with the turning mirror 21 removed. Here, a beam 23 emerging from the projection lens 12 strikes the curved mirror 14, with no intervening turning elements. Note that the same projection lens 12 and curved mirror 14 may be used in both optical systems 10 and 20 if the optical path length of beam 23 is roughly equal to the combined optical path lengths of beams 22 and 13.

FIGS. 3(a)-3(d) shows another optical system 30 for a rear projection television. Light emerging from a projection lens 12 reflects off a turning mirror 21, reflects off a curved mirror 14, reflects off one flat or planar mirror 32, and then strikes a viewing panel 11. The optical path is made up of beams 22, 13, 31 and 33, taken in order.

The flat mirror 32 may be inclined away from horizontal, tilted toward the viewing panel by roughly 8 degrees, although any suitable tilt may be used in an orientation that is largely perpendicular to the screen, such as a tilt in the range of 6 degrees to 10 degrees, or a tilt in the range of 0 to 15 degrees.

One way to describe the orientation of the flat mirror is by its plane of incidence, meaning the plane that contains the incident beam 31 and the exiting beam 33, where the beams are for a central ray that strikes the center of the image. Here, the plane of incidence of the flat mirror 32 is essentially vertical. Note that the orientations of many of the other optical components can be described by their planes of incidence; flat mirrors 16 and 18 and curved mirror 14 all have essentially vertical planes of incidence, although they may deviate from vertical by several degrees or more.

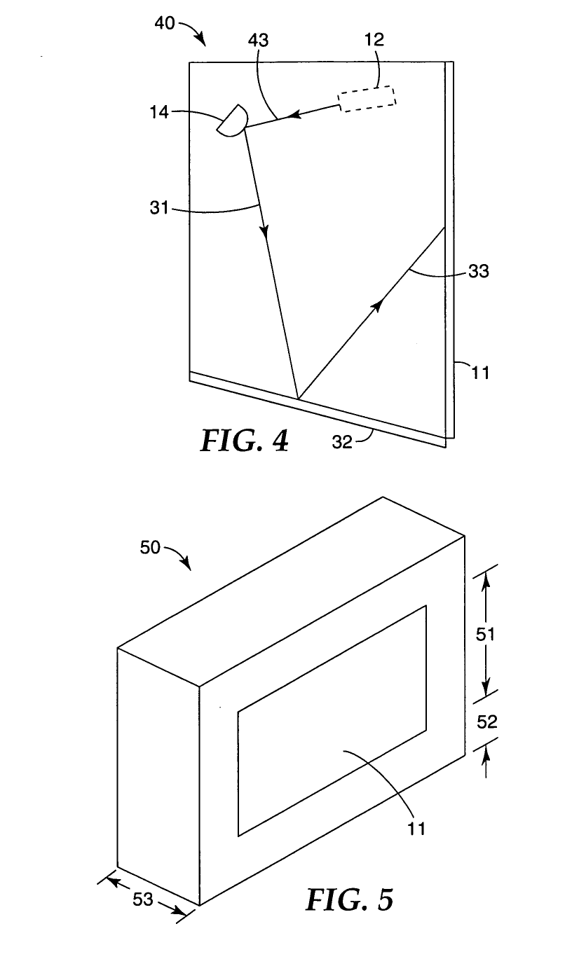

FIG. 4 shows another optical system 40 similar to that shown in FIGS. 3(a)-3(d), but with the turning mirror 21 removed. Note that the same projection lens 12 and curved mirror 14 may be used in both optical systems 30 and 40 if the optical path length of beam 43 is roughly equal to the combined optical path lengths of beams 22 and 13.

It is useful to trace through three detailed examples—two for the optical layout of FIGS. 1(a)-1(d), and one for the layout of FIGS. 3(a)-3(d). Both are presented in accordance with sizes typical of those found in the U.S. marketplace.

The following paragraphs discuss the trigonometry for the layout of FIGS. 1(a)-1(d), in which the flat mirrors are parallel to the screen and perpendicular to the screen. Any suitable set of units may be used for distance and angles, provided that their use in consistent throughout. The following terms can be used to determine the background geometry for the cabinet layout, device orientation, and lens angles. The vertical height of the screen is hₛ₋ᵥ. The desired depth of the cabinet is d_{cab}. The projection distance from the lens exit pupil to the viewing panel is dₚᵣₒⱼ. This horizontal optical axis of the lens may be referred to hereafter as an optical parent axis for brevity. The height from the optical parent axis to the top of the screen is hᵥ₋ₜₒₚ. The height from the optical parent axis to the top corner of the screen is h_{corner}. The height from the optical parent axis to the vertical base of the screen is h_{v-base}. The angle at the exit pupil from the optical parent axis to the top of the screen is θᵥ₋ₜₒₚ. The angle from the optical parent axis to the top corner of the screen is θ_{corner}. The angle from the optical parent axis to the vertical base of the screen is θ_{v-base}. The half-width of the screen is w_{s-hz}.

We consider a simplified case, and carry out some approximate calculations to first order. There will be some small spacing allowed for the placement of the base mirror below the screen base, and distance for the back mirror to be behind the back of the base mirror. But to first order, the first fold at the base mirror, followed by the second fold at the back mirror will put the top ray and the exit pupil back near the top of the screen; the exit pupil will have the curved mirror and the rest of the refractive portion of the lens, but because of the curved mirror, those will be directed away from the screen.

In this simplified case, the depth of the cabinet and the distance from the lens exit pupil to the viewing panel are different by a factor of two, and the height of the screen and the height of the vertical projection also differ by a factor of two. These relationships may be written as dₚᵣₒⱼ=2(d_{cab}) and hᵥ₋ₜₒₚ=2(hₛ₋ᵥ).

The distance from the optical parent axis to the center of the vertical of the screen (and device) determines what is called the “vertical offset,” given as a percentage of the half-screen height. If the optical axis were at the base of the screen, this would be 100%. For the geometry of FIG. 1, the vertical offset v_{offset} is determined by v_{offset}=(hᵥ₋ₜₒₚ−(hₛ₋ᵥ/2))/(hₛ₋ᵥ/2).

The angle from the parent optical axis to the top of the screen and the angle to the base of the screen (which is the minimum angle used in the system) can be determined by θᵥ₋ₜₒₚ=θ_{cab}=tan⁻¹(hₛ₋ᵥ/d_{cab}).

The maximum angle of the system can be found from the width of the screen, using h_{corner}=(hₛ₋ᵥ²+w_{s-hz}²)^{1/2}, and θᵥ₋ₜₒₚ=tan⁻¹(h_{corner}/dₚᵣₒⱼ).

For an exemplary screen diagonal of 50 inches (127 cm), the following exemplary values result. hₛ₋ᵥ is 630 mm. d_{cab} is 175 mm. dₚᵣₒⱼ is 350 mm. hᵥ₋ₜₒₚ is 1260 mm. w_{s-hz} is 560 mm. h_{corner} is 1379 mm. θᵥ₋ₜₒₚ is 74.48°. θ_{corner} is 75.76°. θ_{v-base} is 61.0°. ν_{offset} is 300%. The above derivations and numbers stand by themselves. The actual layout numbers were derived in a spreadsheet and are included in Table 1.

TABLE 1

| Screen and Field Points | Device | | Screen | |
|---|---|---|---|---|
| Screen Diagonal | 0.7 inch (1.8 cm) | | 50 inch (127 cm) | |
| Aspect Ratio | 16:9 | | 16:9 | |
| Screen Height (720 pixels) (hₛ₋ᵥ) | 8.80 | mm | 628.7 | mm |
| Screen Width (1280 pixels) (w_{s-hz}) | 15.65 | mm | 1117.6 | mm |
| Image offset from Parent Axis | 300% | | 300% | |
| (v_{offset}) | | | | |
| Horizontal Edge (w_{s-hz}) | 7.82 | mm | 558.8 | mm |
| Vertical Bottom | 8.80 | mm | 628.7 | mm |
| Vertical Mid | 13.20 | mm | 943.0 | mm |
| Vertical Top (hᵥ₋ₜₒₚ) | 17.60 | mm | 1257.3 | mm |
| Full Parent Radial Extent (h_{corner}) | 19.26 | mm | 1376 | mm |
| Proj depth (exit pupil) (dₚᵣₒⱼ) | | | 349 | mm |
| Calculated max semi-FOV (θ_{corner}) | | | 75.76 | degrees |

The numbers from Table 1 were used in a lens design phase, and then that lens tracing was folded into the cabinet configuration. One exemplary projection lens has a refractive section that has 8 elements, of which 2 are plastic aspheres, and an aspheric convex mirror. The screen has a diagonal dimension of 50 inches (127 cm), and the depth of the cabinet is about 7.5 inches (19 cm). From FIG. 1(d), we see that the whole television cabinet has a reduced depth and a minimal “chin” or “pedestal”, as well as a minimal “brow” or “forehead”. Although the refractive elements in FIG. 1 are shown near the top of the television, they can also reside near the bottom of the cabinet, with a top-to-bottom inversion of the various optical elements.

The second detailed example, also using the layout of FIGS. 1(a)-1(d), is for a 60 inch (152 cm) diagonal screen. Following the same methodology as the first detailed example, the resulting system is described by the values in Table 2.

TABLE 2

| Screen and Field Points | Device | | Screen | |
|---|---|---|---|---|
| Screen Diagonal | 0.78 inch (2 cm) | | 60 inch (152 cm) | |
| Aspect Ratio | 16:9 | | 16:9 | |
| Screen Height (720 pixels) (hₛ₋ᵥ) | 9.81 | mm | 777.0 | mm |
| Screen Width (1280 pixels) (w_{s-hz}) | 17.43 | mm | 1381.3 | mm |
| Image offset from Parent Axis | 235% | | 235% | |
| (v_{offset}) | | | | |
| Horizontal Edge (w_{s-hz}) | 8.72 | mm | 690.6 | mm |
| Vertical Bottom | 6.64 | mm | 526.0 | mm |
| Vertical Mid | 11.54 | mm | 914.5 | mm |
| Vertical Top (hᵥ₋ₜₒₚ) | 16.45 | mm | 1303.0 | mm |

| Full Parent Radial Extent (h_{corner}) | 18.61 | 1475 | |
|---|---|---|---|
| Proj depth (exit pupil) (dₚᵣₒⱼ) | | 381 | mm |
| Calculated max semi-FOV (θ_{corner}) | | 75.51 | degrees |

For the third detailed example, corresponding to the layout of FIGS. 3(a)-3(d) in which only a single reflection is used, off a flat mirror that is just off-perpendicular to the screen. The same quantities defined above apply to this example as well.

For a completely unfolded optical path, in which the optical axis of the lens is horizontal and the screen is vertical, the following approximate values apply, which may be later entered into a spreadsheet for raytracing purposes. For an exemplary screen diagonal of 50 inches (127 cm), the following exemplary values result. hₛ₋ᵥ is 25.3 inches (64.3 cm). d_{cab} is 7.5 inches (19 cm). dₚᵣₒⱼ is 15.0 inches (38.1 cm). hᵥ₋ₜₒₚ is 61.3 inches (156 cm). θᵥ₋ₜₒₚ is 75.5°. θ_{v-base} is 54.3°.

In general, the layouts shown in FIGS. 1-4 may decrease the cabinet size so that the pedestal height divided by the screen height is less than roughly 1/10. Similarly, the layouts shown in FIGS. 1-4 may decrease the cabinet size so that the casing depth divided by the screen height is less than roughly ⅓.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood by those of ordinary skill in the art upon study of this patent document. These and other variations and modifications of the embodiments disclosed herein may be made without departing from the scope and spirit of the invention.

1. A rear projection optical system for forming an image at an at least partially transmissive viewing panel from a first beam emitted from a projection lens, comprising:
a curved mirror for receiving the first beam and reflecting a second beam; a first substantially planar mirror for receiving the second beam and reflecting a third beam; and
a second substantially planar mirror for receiving the third beam and reflecting a fourth beam;
wherein the at least partially transmissive viewing panel receives the fourth beam.

2. The rear projection optical system of claim 1,
wherein the curved mirror directly receives the first beam;
wherein the first substantially planar mirror receives the second beam directly from the curved mirror;
wherein the second substantially planar mirror receives the third beam directly from the first substantially planar mirror; and
wherein the at least partially transmissive viewing panel receives the fourth beam directly from the second substantially planar mirror.

3. The rear projection optical system of claim 1, wherein the viewing panel is substantially vertical.

4. The rear projection optical system of claim 3, wherein the plane of incidence of the curved mirror is substantially vertical and is substantially perpendicular to the viewing panel.

5. The rear projection optical system of claim 3, wherein the first substantially planar mirror is substantially parallel to the viewing panel.

6. The rear projection optical system of claim 3, wherein the second substantially planar mirror is substantially horizontal.

7. The rear projection optical system of claim 1, further comprising the projection lens, the projection lens including a plurality of refractive elements.

8. The rear projection optical system of claim 7, wherein the projection lens further includes at least one reflective element.

9. The rear projection system of claim 1, further comprising:
a casing having a casing depth and a casing front surface, the casing front surface having a bottom edge;
wherein the casing front surface surrounds the at least partially transmissive viewing panel;
wherein the first, second, third and fourth beams are entirely inside the casing;
wherein the at least partially transmissive viewing panel has a screen height;
wherein a pedestal height is formed between the bottom of the at least partially transmissive viewing panel and the bottom edge of the casing front surface;
wherein the pedestal height divided by the screen height is less than roughly 1/10; and
wherein the casing depth divided by the screen height is less than roughly ⅓.

10. A rear projection optical system for forming an image at an at least partially transmissive viewing panel from a first beam emitted from a projection lens, comprising:
a curved mirror for receiving the first beam and reflecting a second beam; and
a substantially planar mirror for receiving the second beam and reflecting a third beam, the substantially planar mirror being non-parallel to the at least partially transmissive viewing panel;
wherein the at least partially transmissive viewing panel receives the third beam.

11. The rear projection optical system of claim 10,
wherein the curved mirror directly receives the first beam;
wherein the substantially planar mirror receives the second beam directly from the curved mirror;
wherein the at least partially transmissive viewing panel receives the third beam directly from the substantially planar mirror.

12. The rear projection optical system of claim 10, wherein the viewing panel is substantially vertical.

13. The rear projection optical system of claim 12, wherein the plane of incidence of the curved mirror is substantially vertical and is substantially perpendicular to the viewing panel.

14. The rear projection optical system of claim 12, wherein the plane of incidence of the substantially planar mirror is substantially vertical and is substantially perpendicular to the viewing panel.

15. The rear projection optical system of claim 14, wherein the substantially planar mirror deviates from horizontal by less than 15 degrees.

16. The rear projection optical system of claim 15, wherein the substantially planar mirror deviates from horizontal by more than 6 degrees but less than 10 degrees.

17. The rear projection optical system of claim 10, wherein the projection lens includes a plurality of refractive elements.

18. The rear projection optical system of claim 17, wherein the projection lens further includes at least one reflective element.

19. The rear projection system of claim 10, further comprising:
a casing having a casing depth and a casing front surface, the casing front surface having a bottom edge;
wherein the casing front surface surrounds the at least partially transmissive viewing panel;
wherein the first, second and third beams are entirely inside the casing;
wherein the at least partially transmissive viewing panel has a screen height;
wherein a pedestal height is formed between the bottom of the at least partially transmissive viewing panel and the bottom edge of the casing front surface;
wherein the pedestal height divided by the screen height is less than roughly 1/10; and
wherein the casing depth divided by the screen height is less than roughly ⅓.

20. A rear projection television, comprising:
a casing having a projection screen;
a projection lens that does not include any curved mirrors; and
an optical path from the projection lens to the projection screen, the optical path including exactly one curved mirror and at least one substantially planar mirror that is non-parallel to the at least partially transmissive viewing panel.

21. The rear projection television of claim 20, wherein the projection screen includes a Fresnel lens having facets that utilize total internal reflection.

22. The rear projection system of claim 20,
wherein the casing has a casing depth and a casing front surface, the casing front surface having a bottom edge;
wherein the casing front surface surrounds the projection screen;
wherein the optical path is entirely inside the casing;
wherein the projection screen has a screen height;
wherein a pedestal height is formed between the bottom of the projection screen and the bottom edge of the casing front surface;
wherein the pedestal height divided by the screen height is less than roughly 1/10; and
wherein the casing depth divided by the screen height is less than roughly ⅓.

23. A rear projection television, comprising:
a casing having a casing depth and a casing front surface, the casing front surface having a bottom edge;
a projection screen embedded in and surrounded by the casing front surface, the projection screen having a screen height;
a projection lens; and
an optical path extending between the projection lens and the projection screen, the optical path being entirely inside the casing;
wherein a pedestal height is formed between the bottom of the projection screen and the bottom edge of the casing front surface;
wherein the pedestal height divided by the screen height is less than roughly 1/10;
wherein the casing depth divided by the screen height is less than roughly ⅓; and
wherein the optical path includes at most three reflections.

24. The rear projection television of claim 23, wherein the at most three reflections include one reflection from a substantially curved surface and at most two reflections from substantially planar surfaces.

25. The rear projection television of claim 24, wherein the at most three reflections include only one reflection from a substantially curved surface.
